(19) United States
(12) Patent Application Publication
(10) Pub. No.: US 2013/0342461 A1
(43) Pub. Date: Dec. 26, 2013

(54) HEATING DEVICE AND MOUSE USING SAME

(71) Applicants: Hon Hai Precision Industry Co., Ltd., New Taipei (TW); Hong Fu Jin Precision Industry (Shenzhen) Co., Ltd., Shenzhen (CN)

(72) Inventors: TEN-CHEN HO, New Taipei (TW); XIAO-LIAN HE, Shenzhen (CN)

(21) Appl. No.: 13/917,683

(22) Filed: Jun. 14, 2013

(30) Foreign Application Priority Data
Jun. 20, 2012 (CN) 2012102046091

(51) Int. Cl. G06F 3/033

(52) U.S. Cl. CPC G06F 3/033
USPC 345/163

(57) ABSTRACT

An exemplary computerized mouse includes a heating device which can warm a hand of a user when the computerized mouse is operated. The heating device includes a first sensing device, a heating member, a temperature regulator, and a controller. The first sensing device generates a first sensing signal when the computerized mouse is operated. The temperature regulator generates a temperature signal representative of a predetermined temperature that the computerized mouse is heated to. The controller controls the heating member to heat an exterior shell of the computerized mouse to the predetermined temperature when the controller receives the first sensing signal and the temperature signal.

### BACKGROUND

1. Technical Field

The present disclosure relates to computerized mice, and more particularly, to a computerized mouse having a heating device.

2. Description of Related Art

A peripheral device, such as a mouse, may be used with a computer to control one or more operations of the computer. During the winter or in cold temperatures, if a user uses a mouse for a long time, a hand of the user operating the mouse will feel cold and uncomfortable.

What is needed, therefore, is to provided an item which overcomes the above-mentioned problems.

### BRIEF DESCRIPTION OF THE DRAWINGS

FIG. 1 is a schematic block diagram illustrating one embodiment of a computerized mouse.

FIG. 2 is an enlarged, isometric, exploded view of the computerized mouse of FIG. 1.

### DETAILED DESCRIPTION

Reference will be made to the drawing to describe specific exemplary embodiments of the present disclosure in detail.

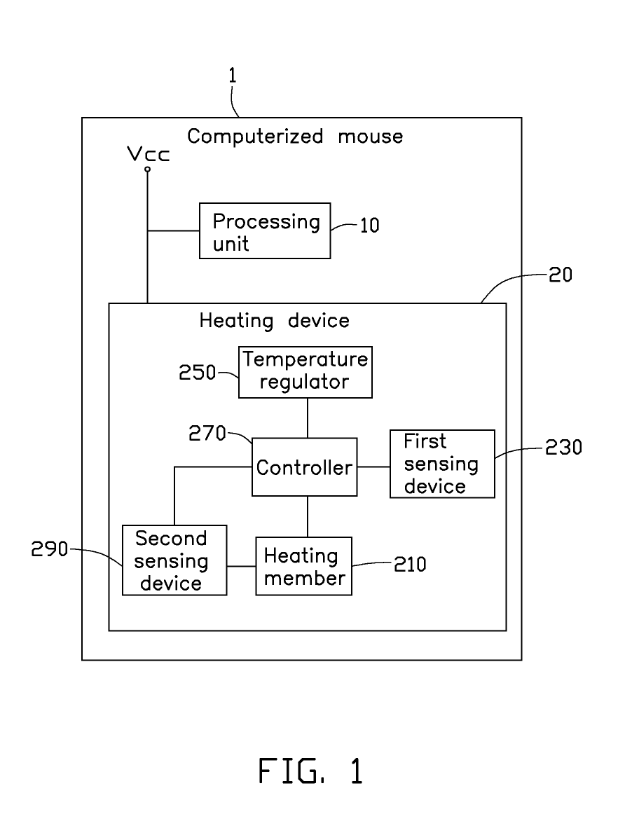

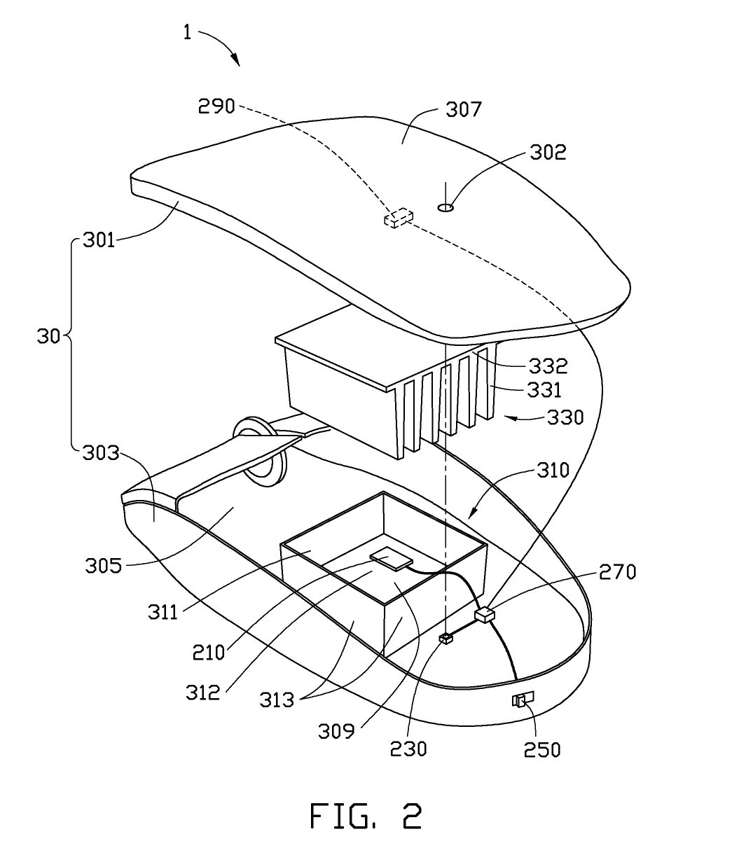

FIG. 1 is a computerized mouse 1 of the embodiment. The computerized mouse 1 includes a processing unit 10 and a heating device 20. The heating device 20 heats an exterior shell, such as a top surface 307, (see FIG. 2) of the computerized mouse 1, such that the computerized mouse 1 can warm a hand of a user operating the computerized mouse 1. The processing unit 10 generates corresponding control signals based on operations from the user, and outputs the control signals to a computer or other signal receiving devices (not shown). The processing unit 10 and the heating device 20 receive an identical voltage Vcc, and work under drive of the voltage Vcc. The voltage Vcc may be a voltage received from the computer via a USB interface or a PS/2 interface, or a voltage set in the computerized mouse 1, for example.

The heating device 20 includes a heating member 210, a first sensing device 230, a temperature regulator 250, a controller 270, and a second sensing device 290.

The controller 270 is electrically connected to the heating member 210, the first sensing device 230, the temperature regulator 250, and the second sensing device 290.

The heating member 210 heats the surface of computerized mouse 1. In the embodiment, the heating member 210 may be an electro-thermal converter, such as a heating wire for example, for converting electrical energy into thermal energy. In alternative embodiments, the heating member 210 may be a microwave heating member, or an infrared heating member, for example.

The first sensing device 230 senses whether the computerized mouse 1 is being operated by the user, and outputs a first sensing signal when the computerized mouse 1 is being operated by the user. In the embodiment, the first sensing device 230 may be an infrared sensor, for example. The first sensing device 230 emits infrared rays to the exterior shell of the computerized mouse 1, receives the infrared reflected by the exterior shell of the computerized mouse 1 when the computer mouse 1 is being operated by the user, and outputs the first sensing signal to the controller 270 based on an exterior shell of reflected infrared rays.

The temperature regulator 250 generates one or more different temperature signals, and outputs a corresponding temperature signal to the controller 270 based on a selection from the user. The one or more different temperature signals are representative of one or more predetermined temperatures that the top surface 307 of the computerized mouse 1 will be heated to and maintained at when the computerized mouse 1 is operated. In the embodiment, the temperature regulator 250 may be a rotary switch, for example. The temperature regulator 250 includes a rotatable member (not shown) and a plurality of selectable contact positions (not shown). The temperature regulator 250 generates the one or more different temperature signals via the rotatable member contacting the contact positions. In addition, the temperature regulator 250 may be a press button switch, for example. Accordingly, the temperature regulator 250 may generate only one temperature signal when the temperature regulator 250 is pressed.

Taking the temperature regulator 250, which includes four contact positions for example, when the rotatable member contacts the four contact positions correspondingly, the temperature regulator 250 correspondingly generates a first temperature signal, a second temperature signal, a third temperature signal, and an off signal, respectively. The first temperature signal represents a first predetermined temperature 60° C. (as an example) that heats the top surface 307 of the computerized mouse 1. The second temperature limiting signal represents a second temperature 45° C. (as an example) that heats the top surface 307 of the computerized mouse 1. The third temperature limiting signal represents a third temperature 35° C. (as an example) that heats the top surface 307 of the computerized mouse 1. The off signal is used to turn off the heating device 20 to stop heating the top surface 307 of the computerized mouse 1. Accordingly, the user via the temperature regulator 250 controls a temperature of the computerized mouse 1.

The second sensing device 290 senses a current temperature of the top surface 307 of the computerized mouse 1, and outputs a second sensing signal to the controller 270 based on the sensed temperature. The second sensing device 290 may be a temperature sensor, for example.

The controller 270 controls the heating member 210 to heat the top surface 307 of the computerized mouse 1 to a predetermined temperature, based on a corresponding temperature signal received from the temperature regulator 250. In addition, the controller 270 controls the temperature of the top surface 307 of the computerized mouse 1 to be maintained at the predetermined temperature substantially, via controlling the operation of heating member 210 based on the second sensing signal. In other words, after the temperature of the top surface 307 of the computerized mouse 1 is heated to the predetermined temperature represented by the received temperature signal from the temperature regulator 250. Then the temperature of the top surface 307 of the computerized mouse 1 is maintained at the predetermined temperature, during a period that the computerized mouse 1 is operated.

In detail, when the controller 270 receives the first sensing signal and a corresponding temperature signal, the controller 270 controls the heating member 210 to heat the computerized mouse 1, and compares the current temperature represented by the second sensing signal with the predetermined temperature represented by the received temperature signal. When the current temperature represented by the second sensing signal is higher than the predetermined temperature represented by the received temperature signal. Then the controller 270 controls the heating member 210 to stop heating the computerized mouse 1, such that the current temperature of the top surface 307 of the computerized mouse 1 is maintained at the predetermined temperature represented by the received temperature signal. In contrast, when the current temperature represented by the second sensing signal is lower than the predetermined temperature represented by the received temperature signal, the controller 270 controls the heating member 210 to continue heating the computerized mouse until the current temperature of the computerized mouse 1 is substantially identical to the predetermined temperature represented by the received temperature signal.

When the controller 270 does not receive the first sensing signal from the first sensing device 230, that is, the computerized mouse 1 is not operated, the controller 270 controls the heating device 210 and the second sensing device 290 to stop working.

FIG. 2 shows that in the embodiment, the computerized mouse 1 further includes a shell 30, a left key-press (not labeled), a right key-press (not labeled), and a roller wheel (not labeled). The roller wheel is positioned between the left key-press and the right key-press. The heating device further includes a supporting member 310 and a heat conducting device 330. The shell 30 includes a top shell 301 and a bottom shell 303. The left key-press, the right key-press, and the top shell 301 cooperatively form a curve surface (not labeled). The left key-press, the right key-press, the top shell 301, and the bottom shell 303 cooperatively define a first receiving space 305. The bottom shell 303 is used to contact a support surface of an object (not shown) for supporting the computerized mouse 1, and the top shell 301 is used to contact a hand of the user. An external surface of the top shell 301 acts as the top surface 307 of the computerized mouse 1. The heating device 20 and the processing unit 10 are received in the shell 30.

The supporting member 310 includes a base 312 and a plurality of sidewalls 313. The base 312 is positioned on a side of the bottom shell 303 adjacent to the top shell 301 and corresponds to an area of the top shell 301 of the computerized mouse 1 that is usually contacted by the user. In the embodiment, the base 312 is adhered to the bottom shell 303. In alternative embodiments, the base 312 may be fixed on the bottom shell 303. The sidewalls 313 extend from the base 312 towards the top shell 301. The sidewalls 313 are connected one-by-one in sequence and cooperatively define a second receiving space 309 having an opening 311. The opening 311 is directly facing the top shell 301. The heights of the sidewalls 313 are substantially identical. The supporting member 310 is made of heat insulation material, such that the top shell 301 is heated, and the bottom shell 303 and the first receiving space 305 are not directly heated when the heating member 210 is working. The heating member 210 is received in the second receiving space 309 of the supporting member 310 and positioned on the base 312.

The heat conducting device 330 includes a base 332 and a plurality of heat dissipating plates 331 extending from the base 330. The heat dissipating plates 331 are received in the second receiving space 309 of the supporting member 310 through the opening 311 and positioned above the heating member 210. The base 332 covers the opening 311. The heat dissipating plates 331 transfer the heat dissipated from the heating member 210 to the top shell 301 via the base 332, to heat the top surface 307 of the computerized mouse 1. The heat conducting device 330 is made of aluminum material. The base 332 is in an arc shape or a rectangular shape. In alternative embodiment, the heating member 210 is attached on the heat dissipating plates 331. A sum of a height of a sidewall 313 and a thickness of the base 332 may be substantially equal to a height of the first receiving space 305, for example.

The first sensing device 230 and the controller 270 are positioned on the same side of the bottom shell 301 with the supporting member 310. The top shell 301 defines a through hole 302 positioned on the area of the top shell 301 that the computerized mouse 1 is usually contacted. The through hole 302 corresponds to the first sensing device 230. The infrared rays emitted from the first sensing device 230 is transmitted to the exterior of the computerized mouse 1 via the through hole 302.

The temperature regulator 250 is positioned on the bottom shell 303 and is exposed from the bottom shell 303.

The second sensing device 290 is positioned on a side of the top shell 301 adjacent to the bottom shell 303, and directly opposite to the opening 311. The second sensing device 290 may be adhered to the top shell 301, for example. Because of the thinness of the top shell 301, a temperature of the external surface of the computerized mouse 1 is substantially equal to a temperature of an inner surface of the computerized mouse 1 opposite to the external face. Accordingly, the second sensing device 290 senses the current temperature of the top surface 307 via sensing the temperature of the inner surface of the computerized mouse 1.

Since the heating device 20 heats the computerized mouse 1 when the controller 210 receives the first sensing signal and a corresponding temperature signal, the computerized mouse 1 warms the hand of the user operating the computerized mouse 1. Accordingly, the user will feel warm even in cold weather conditions.

Furthermore, because the heat device 20 heats the computerized mouse 1 when the computerized mouse 1 is being operated and does not heat the computerized mouse 1 when the computerized mouse 1 is not operated, the power consumed by the computerized mouse 1 decreases.

Moreover, the controller 270 controls the temperature of the computerized mouse 1 to be constant, based on the second sensing signal from the second sensing device 290, improving the performance of the computerized mouse 1.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computerized mouse, comprising:
a shell defining a first receiving space; and
a heating device received in the first receiving space of the shell, the heating device comprising:
a first sensing device sensing whether the computerized mouse is operated, and outputting a first sensing signal when the computerized mouse is operated;
a heating member heating an exterior shell of the computerized mouse;
a temperature regulator generating a temperature signal representative of a predetermined temperature that the computerized mouse is heated to; and
a controller controlling the heating member to heat the computerized mouse to the predetermined temperature when the controller receives the first sensing signal and the temperature signal.

2. The computerized mouse according to claim 1, wherein the first sensing device does not output the first sensing signal to the controller when the computerized mouse is not operated such that the controller does not control the heating member to heat the computerized mouse.

3. The computerized mouse according to claim 1, wherein the first sensing device is an infrared sensor, the first sensing device emits infrared rays to the exterior shell of the computerized mouse, and the first sensing device outputs the first sensing signal when the first sensing device receives the infrared rays reflected from the exterior shell of the computerized mouse when the computerized mouse is operated.

4. The computerized mouse according to claim 1, wherein the heating device further comprises a second sensing device, the second sensing device senses a current temperature of the computerized mouse, and outputs a second sensing signal representative of the current temperature of the computerized mouse to the controller; the controller compares the current temperature with the predetermined temperature, and controls the heating member to heat the computerized mouse to the predetermined temperature when the current temperature is unequal to the predetermined temperature.

5. The computerized mouse according to claim 4, wherein the first sensing device does not output the first sensing signal to the controller when the computerized mouse is not operated such that the controller does not control the second sensing device to sense the current temperature of the computerized mouse.

6. The computerized mouse according to claim 4, wherein the shell comprises a top shell and a bottom shell, the top shell and the bottom shell cooperatively define the first receiving space, the heating device further comprises a supporting member receiving in the first receiving space, the supporting member is made of heating insulating material, the supporting member comprises a base and a plurality of sidewalls extending from the base towards the top shell, the base is fixed on an inner side of the bottom shell, and the sidewalls are connected one-by-one in sequence and cooperatively define a second receiving space having an opening, the opening is directly facing the top shell, and the heating member is received in the second receiving space of the supporting member and positioned on the base.

7. The computerized mouse according to claim 6, wherein the heating device further comprises a heat conducting device received in the second receiving space of the supporting member through the opening, and the heat conducting device transfers the heat generated by the heating member to the exterior shell.

8. The computerized mouse according to claim 7, wherein the heat conducting device comprises a base and a plurality of heat dissipating plates extending from the base towards the bottom shell, the heat dissipating plates are received in the second receiving space of the supporting member through the opening, and the base of the heat conducting device covers the opening.

9. The computerized mouse according to claim 6, wherein the first sensing device and the controller are positioned on the inner side of the bottom shell.

10. The computerized mouse according to claim 6, wherein the second sensing device is positioned on the top shell.

11. The computerized mouse according to claim 10, wherein the second sensing device is positioned on an inner side of the top shell and directly opposite to the opening.

12. The computerized mouse according to claim 6, wherein the heights of the sidewalls of the supporting member are substantially identical, and a sum of a height of a sidewall and a thickness of the base of the heat conducting device is substantially equal to a height of the first receiving space where the supporting member is positioned.

13. The computerized mouse according to claim 1, wherein the temperature regulator is a switch.

14. A heating device for heating a computerized mouse, comprising:
a first sensing device sensing whether the computerized mouse is operated, and outputting a first sensing signal when the computerized mouse is operated;
a heating member heating an exterior shell of the computerized mouse;
a temperature regulator generating a temperature signal representative of a predetermined temperature that the computerized mouse is heated to; and
a controller controlling the heating member to heat the computerized mouse to the predetermined temperature when the controller receives the first sensing signal and the temperature signal.

15. The computerized mouse according to claim 14, wherein the first sensing device does not output the first sensing signal to the controller when the computerized mouse is not operated such that the controller does not control the heating member to heat the computerized mouse.

16. The heating device according to claim 14, wherein the first sensing device is an infrared sensor, the first sensing device emits infrared rays to the exterior shell of the computerized mouse, and the first sensing device outputs the first sensing signal when the first sensing device receives the infrared rays reflected from the exterior shell of the computerized mouse when the computerized mouse is operated.

17. The heating device according to claim 14, wherein the heating device further comprises a second sensing device, the second sensing device senses a current temperature of the computerized mouse, and outputs a second sensing signal representative of the current temperature of the computerized mouse to the controller; the controller compares the current temperature with the predetermined temperature, and controls the heating member to heat the computerized mouse to the predetermined temperature when the current temperature is unequal to the predetermined temperature.

18. The computerized mouse according to claim 17, wherein the first sensing device does not output the first sensing signal to the controller when the computerized mouse is not operated such that the controller does not control the second sensing device to sense the current temperature of the computerized mouse.

19. A computerized mouse, comprising:
a shell defining a first receiving space; and
a heating device received in the first receiving space of the shell, the heating device comprising:
a first sensing device sensing whether the computerized mouse is operated, and outputting a first sensing signal when the computerized mouse is operated;
a heating member heating an exterior shell of the computerized mouse;
a temperature regulator generating a plurality of temperature signals representative of different predetermined temperatures that the computerized mouse is heated to; and
a controller controlling the heating member to heat the computerized mouse to one of the different predetermined temperatures when the controller receives the first sensing signal and a corresponding temperature signal.

20. The computerized mouse according to claim 19, wherein which one temperature signal is generated via an operation to the temperature regulator.
